(19) United States
(12) Patent Application Publication
(10) Pub. No.: US 2015/0180403 A1
(43) Pub. Date: Jun. 25, 2015

(54) SYSTEM AND METHOD FOR CONTROLLING A MOTOR CONTROLLER

(71) Applicant: Regal Beloit America, Inc., Beloit, WI (US)

(72) Inventors: Marc C. McKinzie, West Milton, OH (US); Bennie Monroe Steele, Dayton, OH (US); Nathan Eric Snell, Tipp City, OH (US)

(73) Assignee: Regal Beloit America, Inc., Beloit, WI (US)

(21) Appl. No.: 14/136,519

(22) Filed: Dec. 20, 2013

(51) Int. Cl. H02P 31/00

(52) U.S. Cl. CPC H02P 31/00

(57) ABSTRACT

An adjustment module configured to be coupled to an electric motor controller is provided. The adjustment module includes at least one potentiometer and a communication interface coupled to the input device. The potentiometer receives a control signal from a user. The communication interface is configured to communicate the control signal to the electric motor controller.

### BACKGROUND

The field of the disclosure relates generally to electric motors, and more particularly, to systems and methods for controlling an electric motor controller.

At least some known systems used in fluid moving applications, such as pumping water or moving air (e.g., in a heating, ventilation, and air conditioning (HVAC) system) include a motor, for example a variable speed electric motor, coupled to a motor controller. Generally, a physical user interface is coupled to the motor controller to enable a user to view a status of the motor and/or to enter operating parameters for the motor. Other known systems include an automation controller that is physically connected to a motor controller, for example by a networking cable, and to other devices, such as lights, heaters, a chlorine generator, auxiliary pumps, valves, etc. Such automation controllers may be configured to communicate wirelessly with a computing device to present an application that enables a user to view a status of one or more devices controlled by the automation controller and to enter operating parameters for the one or more devices. However, including a physical user interface with a motor controller or adding an automation controller to act as a bridge between a motor controller and an application presented on a portable computing device has an associated cost.

### BRIEF DESCRIPTION

In one aspect, an adjustment module configured to be coupled to an electric motor controller is provided. The adjustment module includes at least one potentiometer and a communication interface coupled to the potentiometer. The potentiometer receives a control signal from a user. The communication interface is configured to communicate the control signal to the electric motor controller.

In another aspect, a method for communicating with a motor controller including a wireless communication device and a computing device coupled to the wireless communication device is provided. The method includes communicatively coupling an adjustment module to the motor controller. The method also includes receiving a control signal from a user by at least one potentiometer included within the adjustment module. The method further includes communicating the control signal to the electric motor controller by a communication interface coupled to the at least one potentiometer.

In another aspect, an electric motor is provided. The electric motor includes an electric motor controller configured to operate the electric motor according to settings stored in the electric motor controller. The electric motor also includes an adjustment module configured to be coupled to an electric motor controller is provided. The adjustment module includes at least one potentiometer and a communication interface coupled to the potentiometer. The potentiometer receives a control signal from a user. The communication interface is configured to communicate the control signal to the electric motor controller.

### BRIEF DESCRIPTION OF THE DRAWINGS

FIG. 1 is a block diagram of an example system including a motor controller that is coupled to a motor that drives a pump.

FIG. 2 is a block diagram of an example adjustment module that may be in communication with the motor controller of FIG. 1.

### DETAILED DESCRIPTION

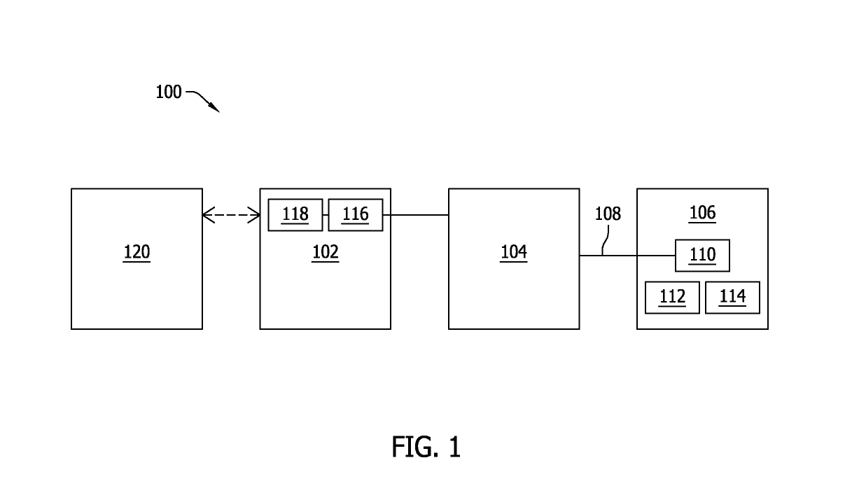

FIG. 1 is a block diagram of an example system 100 that includes a motor controller 102 coupled to a motor 104. In some implementations, motor controller 102 is incorporated within motor 104. Motor 104 may be an electric motor and, in some implementations, is an electric variable speed motor. Motor 104 drives a pump 106. More specifically, motor 104 is coupled to pump 106 by a shaft 108. Shaft 108 rotates to turn an impeller 110. Pump 106 includes an inlet 112 and an outlet 114. In some implementations, system 100 is used to move liquid, such as water, in a pool, spa, or other aquatic environment. In such implementations, inlet 112 receives the water and outlet 114 expels the received water. In other implementations, motor 104 drives a fan for moving air, for example in a heating, ventilation, and air conditioning (HVAC) system. Motor controller 102 includes a computing device 116 and a wireless communication device 118. Motor controller 102 is configured to operate motor 104 according to settings stored in a memory (not shown) of computing device 116. The settings may include modes of operation, wherein each mode is associated with a time period and a speed. For example, one mode may be to operate motor 104 at 2100 rotations per minute (RPM) from 1:00 PM to 6:00 PM. One or more other modes may be based on sensing water chemistry and/or water clarity. In other implementations, the time period is specified as a duration, such as five hours, rather than as an absolute start time and absolute stop time. Wireless communication device 118 is coupled to computing device 116. As described herein, wireless communication device 118 enables computing device 116 to wirelessly communicate with an adjustment module 120.

In the exemplary embodiment, adjustment module 120 is communicatively coupled to motor controller 102. In one implementation, adjustment module 120 is incorporated within motor controller 102. In another implementation, adjustment module 120 is a standalone module that is coupled to motor controller 102 either by a cable or a wireless connection. Adjustment module 120 is configured to enable a user to adjust operating parameters stored on motor controller 102.

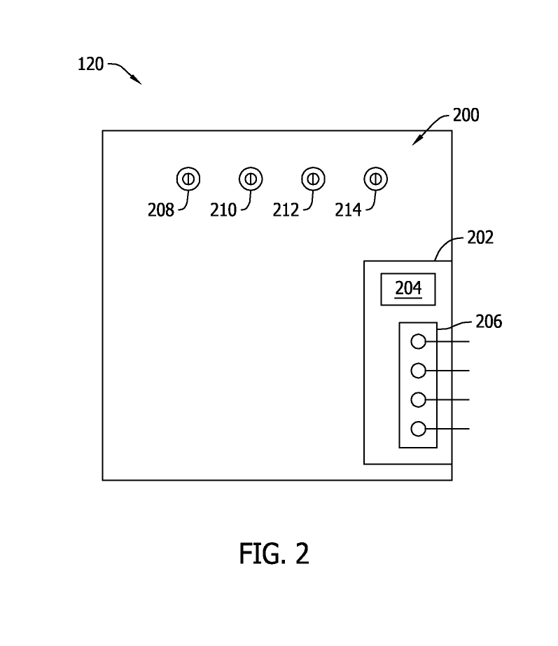

FIG. 2 is a block diagram of an example adjustment module 120 that may be in communication with motor controller 102 (FIG. 1). In the exemplary embodiment, adjustment module 120 is communicatively coupled to motor controller 102. In one implementation, adjustment module 120 is incorporated within motor controller 102. In another implementation, adjustment module 120 is a standalone module that is coupled to motor controller 102 either by a cable or a wireless connection. Adjustment module 120 is configured to enable a user to adjust operating parameters stored on motor controller 102.

Adjustment module 120 includes at least one an input device 200 configured to receive a user input. In the exemplary embodiment, input device 200 is an analog potentiometer configured to receive a control input from a user. Alternatively, input device 200 may be any other type of input device that enables adjustment module 120 to function as described herein. Input device 200 receives the control input, which is used to adjust motor operating parameters. Parameters that may be adjusted include, but are not limited to, speed, torque, run time, start/stop time, prime settings, and/or temperature. Adjustment module 120 provides a simple, direct user interface for motor controller 102 to enable continuous adjustment of speed over a full performance range of motor 104. Adjustment module 120 may accept a low voltage signal, an analog signal, or a pulse width modulation signal as inputs to control motor speed and operating durations. In one embodiment, adjustment module 120 includes a microprocessor (not shown) that converts the input signal to a serial (RS-485) command. The serial command is then transmitted to motor controller 102.

Adjustment module 120 also includes a communication interface 202, which is communicatively couplable to another device. For example, communication interface 202 may be a wireless communication device 204 that is communicatively coupled to wireless communication device 118 (FIG. 1) to enable wireless communication with motor controller 102 (FIG. 1), for example through a short range wireless communication protocol such as Bluetooth™ or Z-Wave™ through a wireless local area network (WLAN) implemented pursuant to an IEEE (Institute of Electrical and Electronics Engineers) 802.11 standard (i.e., WiFi), and/or through a mobile phone (i.e., cellular) network (e.g., Global System for Mobile communications (GSM), 3G, 4G) or other mobile data network (e.g., Worldwide Interoperability for Microwave Access (WIMAX)). In some implementations, communication interface 202 is directly capable of enabling such wireless communications. For example, in some implementations, communication interface 202 includes a wireless communication device, such as wireless communication device 118 (FIG. 1). Additionally, communication interface 202 may couple motor controller 102 to motor 104. In such implementations, communication interface 202 may include, for example, one or more conductors for transmitting electrical signals and/or power to and/or from motor 104.

Alternatively, communication interface 202 may be hardwired to motor controller 102. Where a hardwired connection is used, communication interface 202 includes an output device 206 that includes one of a RS-485 connector, a digital serial interface (DSI) connector, a control wire reception terminal, and/or any other type of interface that allows a user to provide a control signal to motor controller 102. For example, the control signal may include a 0-10 volts direct current (VDC) control signal, a 0-5 VDC control signal, a 4-20 milliampere (mA) control signal, and/or any other type of control signal that enables motor controller 102 to function as described herein.

In the exemplary embodiment, adjustment module 120 is configured to receive voltage level signals that represent desired operation of electric motor 104. Where input device 208 is a potentiometer, a user turns input device 208 clockwise or counterclockwise to increase or decrease motor speed, respectively. For example, adjustment module 120 may receive a forward command signal at a first potentiometer 208 directing electric motor 104 to operate in what is defined as a forward direction. Adjustment module 120 may also receive a reverse command signal at a second potentiometer 210 directing electric motor 104 to operate in what is defined as a reverse direction. Adjustment module 120 may also receive a speed control command signal at a third potentiometer 212. For example, the speed control command signal provided to third potentiometer 212 may vary in voltage from 0 to 5 volts, with a higher voltage corresponding to a higher electric motor operating speed. Adjustment module 120 may also receive a start time control command signal at a fourth potentiometer 214. Alternatively, adjustment module 120 may receive command signals representing stop time, prime settings, and/or temperature.

The methods and systems described herein may be implemented using computer programming or engineering techniques including computer software, firmware, hardware or any combination or subset thereof, wherein the technical effect may include at least one of: (a) communicatively coupling an adjustment module to the motor controller; (b) receiving a control signal from a user by at least one input device included within the adjustment module; and (c) communicating the control signal to the electric motor controller by a communication interface coupled to the at least one input device.

While above methods and systems have been described in connection with a motor controller, the principals of the methods and systems described herein may be applied to enable wireless communication with other devices such as chlorinators, pool covers, pool lights, etc.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As compared to known systems and methods for communicating with a motor controller, the systems and methods described herein provide a manual user interface for adjusting motor operating parameters, eliminating the need for an external source or complicated user interface to define motor speed and run duration. The systems and methods described herein simplify setup and installation of the motor. Additionally, the systems and methods described herein reduce development time and costs of motors, while still providing flexibility in motor operating speeds and operating times.

Exemplary embodiments of systems and methods for enabling wireless communication with a motor controller are described herein. The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An adjustment module configured to be coupled to an electric motor controller, said adjustment module comprising:
at least one potentiometer for receiving a control signal from a user; and
a communication interface coupled to said at least one potentiometer and configured to communicate the control signal to the electric motor controller.

2. The adjustment module of claim 1, wherein said potentiometer is adjustable to receive a control signal representing at least one of speed, torque, run time, start time, stop time, prime settings, and temperature.

3. The adjustment module of claim 1, wherein said adjustment module receives a control signal in the form of one of a low voltage signal, an analog signal, and a pulse width modulation signal.

4. The adjustment module of claim 1, wherein said adjustment module is incorporated within the electric motor controller.

5. The adjustment module of claim 1, wherein said adjustment module is a standalone module, said communication interface is a wireless communication interface configured to wirelessly communicate with the electric motor controller.

6. The adjustment module of claim 1, wherein said adjustment module is a standalone module, said communication interface is a wired communication interface configured to be removeably coupled from the electric motor controller.

7. A method for communicating with a motor controller including a wireless communication device and a computing device coupled to the wireless communication device, said method comprising:
communicatively coupling an adjustment module to the motor controller;
receiving a control signal from a user by at least one potentiometer included within the adjustment module; and
communicating the control signal to the electric motor controller by a communication interface coupled to the at least one potentiometer.

8. The method of claim 7, wherein receiving a control signal by at least one potentiometer further comprises receiving a control signal representing at least one of speed, torque, run time, start time, stop time, prime settings, and temperature.

9. The method of claim 7, wherein receiving a control signal by at least one potentiometer further comprises receiving one of a low voltage signal, an analog signal, and a pulse width modulation signal.

10. The method of claim 7, further comprising incorporating the adjustment module within the electric motor controller.

11. The method of claim 7, wherein communicatively coupling an adjustment module to the motor controller comprises communicatively coupling an adjustment module to the motor controller using a wireless connection.

12. The method of claim 7, wherein communicatively coupling an adjustment module to the motor controller comprises communicatively coupling an adjustment module to the motor controller using a wired connection.

13. An electric motor comprising:
an electric motor controller configured to operate said electric motor according to settings stored in said electric motor controller; and
an adjustment module configure to be coupled to said electric motor controller, said adjustment module comprising:
at least one potentiometer for receiving a control signal from a user; and
a communication interface coupled to said at least one potentiometer and configured to communicate the control signal to the electric motor controller.

14. The electric motor of claim 13, wherein said potentiometer is adjustable to receive a control signal representing at least one of speed, torque, run time, start time, stop time, prime settings, and temperature.

15. The electric motor of claim 13, wherein said adjustment module receives a control signal in the form of one of a low voltage signal, an analog signal, and a pulse width modulation signal.

16. The electric motor of claim 13, wherein said adjustment module is incorporated within the electric motor controller.

17. The electric motor of claim 13, wherein said adjustment module is a standalone module, said communication interface is a wireless communication interface configured to wirelessly communicate with said electric motor controller.
